(19) United States
(12) Patent Application Publication
(10) Pub. No.: US 2004/0262898 A1
(43) Pub. Date: Dec. 30, 2004

(54) Vented air bag

(75) Inventors: John G. Bauer, Troy, MI (US); Kurt F. Fischer, Oxford, MI (US); Hector Javier Zarazua Mauleon, Rochester Hills, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/602,316

(22) Filed: Jun. 24, 2003

(51) Int. Cl. B60R 21/30

(52) U.S. Cl. 280/739

(57) ABSTRACT

An apparatus (10) includes an inflatable vehicle occupant protection device (14) and an inflation fluid source (32) actuatable to provide inflation fluid for inflating the inflatable vehicle occupant protection device. The inflatable vehicle occupant protection device (14) is inflatable to an inflated position for helping to protect an occupant (20) of a vehicle (12). The inflatable vehicle occupant protection device (14) includes at least one vent (60) positioned against a vehicle surface (62) while the protection device is in the inflated position to help block inflation fluid from venting through the vent.

### FIELD OF THE INVENTION

The present invention relates to an air bag for helping to protect an occupant of a vehicle upon the occurrence of an event for which occupant protection is desired, such as a vehicle collision.

### BACKGROUND OF THE INVENTION

It is known to provide an inflatable vehicle occupant protection device, such as an air bag, for helping to protect an occupant of a vehicle. One particular type of air bag is a front impact air bag inflatable between an occupant of a front seat of the vehicle and an instrument panel of the vehicle. Such air bags may be driver side air bags or passenger side air bags. When inflated, the driver side and passenger side air bags help protect the occupant from impacts with parts of the vehicle such as the instrument panel and/or a steering wheel of the vehicle.

Passenger side air bags are typically stored in a deflated condition in a housing that is mounted in the vehicle instrument panel. An air bag door is connectable with the housing and/or instrument panel to help conceal and enclose the air bag in a stored condition. Upon deployment of the passenger side air bag, the air bag door opens to permit the air bag to move to an inflated position. The air bag door opens as a result of forces exerted on the door by the inflating passenger side air bag.

Driver side air bags are typically stored in a deflated condition in a housing that is mounted on the vehicle steering wheel. An air bag cover is connectable with the housing and/or steering wheel to help conceal and enclose the air bag in a stored condition. Upon deployment of the driver side air bag, the air bag cover opens to permit the air bag to move to an inflated position. The air bag cover opens as a result of forces exerted on the cover by the inflating driver side air bag.

### SUMMARY OF THE INVENTION

The present invention relates to an apparatus for helping to protect an occupant of a vehicle. The apparatus includes an inflatable vehicle occupant protection device and an inflation fluid source actuatable to provide inflation fluid for inflating the inflatable vehicle occupant protection device. The inflatable vehicle occupant protection device is inflatable to an inflated position for helping to protect the vehicle occupant. The inflatable vehicle occupant protection device includes at least one vent positioned against a vehicle surface while the protection device is in the inflated position, which helps block inflation fluid from venting through the at least one vent.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a passenger side of a vehicle including an apparatus comprising a passenger side air bag in a stored condition and a deployed condition with a vehicle occupant in a first position, according to a first embodiment of the present invention;

FIG. 2 is a schematic illustration of the deployed passenger side air bag of FIG. 1 with the vehicle occupant in a second position;

FIG. 3 is a schematic illustration of a driver side of a vehicle including an apparatus comprising a driver side air bag in a stored condition and a deployed condition with a vehicle occupant in a first position, according to a second embodiment of the present invention;

FIG. 4 is a schematic illustration of the deployed driver side air bag of FIG. 3 with the vehicle occupant in a second position;

FIGS. 5A and 5B illustrate a configuration of an air bag vent for incorporation with the apparatus of the first and second embodiments;

FIGS. 6A and 6B illustrate another configuration of an air bag vent for incorporation with the apparatus of the first and second embodiments;

FIGS. 7A and 7B illustrate yet another configuration of an air bag vent for incorporation with the apparatus of the first and second embodiments; and

FIGS. 8A and 8B illustrate still another configuration of an air bag vent for incorporation with the apparatus of the first and second embodiments.

### DESCRIPTION OF THE PREFERRED EMBODIMENTS

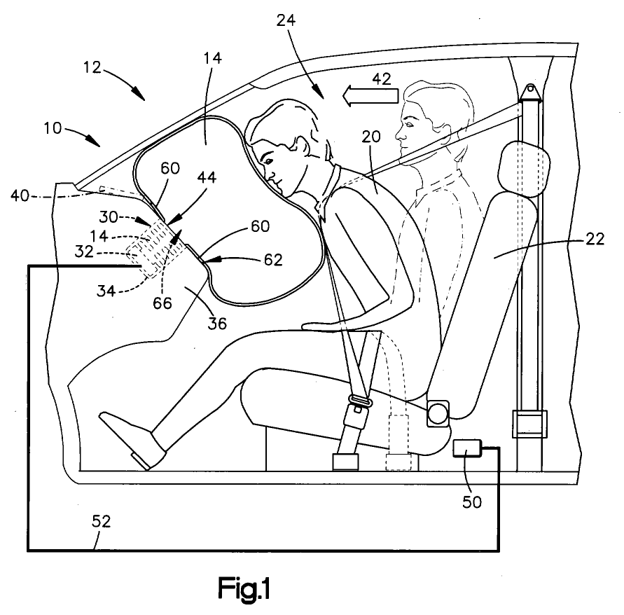

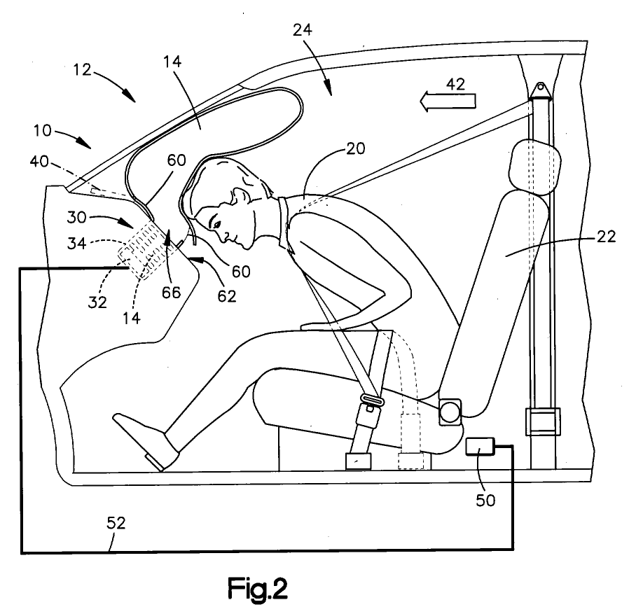

The present invention relates to an inflatable vehicle occupant protection device for helping to protect an occupant of a vehicle. More particularly, the present invention relates to a front impact air bag having an improved vent configuration. According to a first embodiment illustrated in FIGS. 1 and 2, the apparatus 10 comprises a passenger side front impact air bag 14 for helping to protect an occupant 20 in a passenger side 24 of a vehicle 12. In the embodiment illustrated in FIGS. 1 and 2, the occupant 20 is positioned in a seat 22 in the passenger side 24 of the vehicle 12.

As illustrated in FIGS. 1 and 2, the air bag 14 may be part of an air bag module 30 that includes an inflator 32 and a housing 34. The air bag 14 has a stored condition, indicated by dashed lines in FIGS. 1 and 2, in which the air bag is folded and placed in the housing 34. The housing 34 and thus the module 30 is connected to a dash or instrument panel 36 of the vehicle 12 on the passenger side 24 of the vehicle. The housing 34 helps contain and support the air bag 14 and inflator 32 in the instrument panel 36.

An air bag door 40 is releasably connected to the instrument panel 36 and/or the housing 34. In a closed condition (not shown), the air bag door 40 forms a cover for the module 30 and helps enclose the air bag 14 in the stored condition in the housing 34. The door 40 is movable to an opened condition illustrated in FIGS. 1 and 2 to uncover an opening 44 through which the air bag 14 may be deployed from the stored condition in the housing 34. The door 40 may be connected to the vehicle 12, e.g., the instrument panel 36, by means (not shown), such as a hinge, strap or tether.

The inflator 32 is actuatable to provide inflation fluid for inflating the air bag 14. The inflator 32 may be of any known type, such as stored gas, solid propellant, augmented, and hybrid. The apparatus 10 includes a sensor, illustrated schematically at 50, for sensing an event for which inflation of the air bag 14 is desired, such as a collision. The inflator 32 is operatively connected to the sensor 50 via lead wires 52.

Upon sensing the occurrence of an event for which inflation of the air bag 14 is desired, such as a vehicle collision, the sensor 50 provides a signal to the inflator 32 via the lead wires 52. Upon receiving the signal from the sensor 50, the inflator 32 is actuated and provides inflation fluid to the air bag 14 in a known manner. The inflating air bag 14 exerts a force on the door 40 that moves the door to the opened condition. The air bag 14 inflates from the stored condition to a deployed condition illustrated in solid lines in FIGS. 1 and 2. The air bag 14, while inflated, helps protect the vehicle occupant 20 from impacts with parts of the vehicle 12, such as the instrument panel 36.

According to the present invention, the air bag 14 includes vents illustrated schematically at 60. The vents 60 are arranged about an opening of the air bag 14 referred to as a mouth or throat 66 of the air bag. The throat 66 of the air bag 14 is connected to the air bag module 30, e.g., to the housing 34. The inflator 32, when actuated, directs inflation fluid through the throat 66 into the air bag 14. The vents 60 are presented facing toward a surface 62 of the vehicle 12. In the first embodiment illustrated in FIGS. 1 and 2, the surface 62 comprises a surface of the instrument panel 36 adjacent the opening 44.

In FIG. 1, the occupant 20 moves from a normal seated position in a forward direction indicated generally by the arrow labeled 42 in FIG. 1, toward the instrument panel 36. At the same time, the air bag 14 inflates and deploys from its stored position in the instrument panel 36. Since the occupant 20 starts moving from the normal seated position, the air bag 14 is free to inflate to a normal inflated position illustrated in FIG. 1. The occupant 20 thus moves into engagement with the normally inflated and positioned air bag 14 as shown in FIG. 1.

When the air bag is in the normally inflated position of FIG. 1, the vents 60 are positioned against the surface 62. The vents 60 are thus closed and inflation fluid flow through the vents is blocked. When the occupant 20 engages the air bag 14, the occupant pushes the air bag towards the instrument panel 36. As a result, the portion of the air bag 14 including the vents 60 is urged against the surface 62. This helps hold the vents 60 closed and helps further to block inflation fluid-from flowing through the vents. The vents 60, being held closed when the air bag 14 is in the normally inflated position, helps the air bag 14 maintain a desired inflated pressure. As a result, in the normally inflated position, the air bag 14 helps protect the vehicle occupant 20 from impacts with parts of the vehicle 12, such as the instrument panel 36.

In FIG. 2, the occupant 20 moves in the forward direction indicated by the arrow labeled 42 into engagement with the air bag 14 from a position in which the occupant is leaned away from the normal seating position of FIG. 1. Specifically, in FIG. 2, the occupant 20 is leaned forward from the normal seating position as the air bag 14 inflates and deploys from its stored position in the instrument panel 36. Since the occupant 20 is leaned forward from the normal seated position, the occupant blocks the air bag 14 from inflating to the normal inflated position illustrated in FIG. 1. Instead, the air bag 14 inflates to a position away from the normally inflated position, as represented in FIG. 2.

Because the air bag 14 is blocked from inflating to the normal position, at least a portion of the throat 66, and thus at least some of the vents 60, are spaced away from the surface 62 when the air bag is in the inflated position. Thus, in the inflated condition of FIG. 2, at least some of the vents 60 are free to open and vent inflation fluid from the air bag 14. As a result, the air bag may have a reduced inflation pressure and/or may move toward the occupant with a reduced amount of force.

Those skilled in the art will appreciate that the air bag 14 illustrated in FIGS. 1 and 2, when inflated, is adapted to deploy and pressurize to a normally inflated position when the air bag is free from obstruction. The air bag 14 may thus be maintained at a desired inflation pressure, which allows the air bag to absorb impact forces and help protect the vehicle occupant. The air bag 14 is also adapted to vent inflation fluid when an obstruction, such as an occupant positioned away from the normal seated position, blocks the air bag from inflating and deploying to the normal inflated position. As a result, the air bag 14 may inflate toward the occupant with a reduced force.

The air bag vents 60 of the present invention help maintain the air bag 14 at a desired inflation pressure when deployed to the normally inflated position. The air bag vents 60 of the present invention also help vent inflation fluid from the air bag 14 in the event that the air bag does not inflate to its normal inflated position.

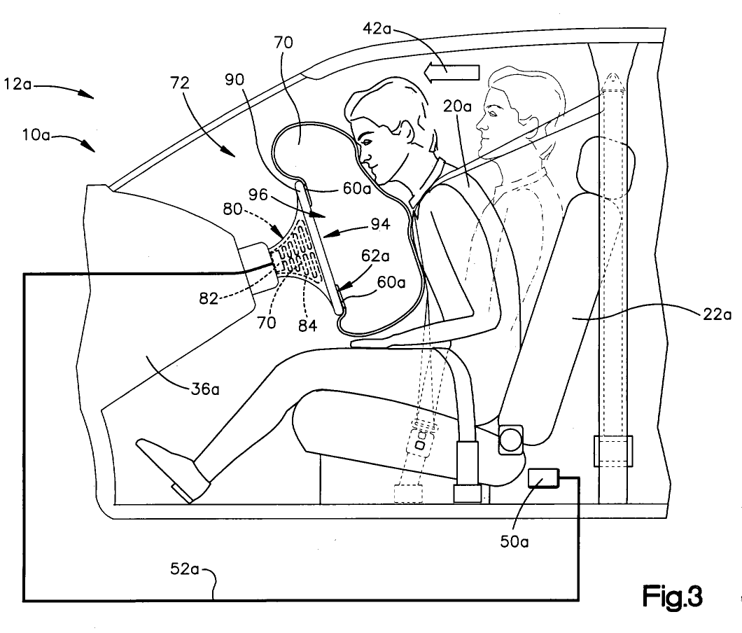

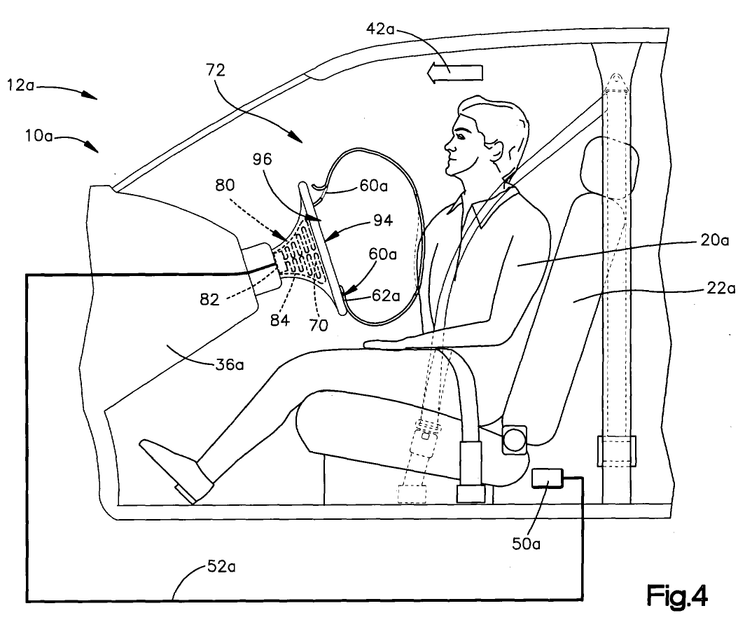

A second embodiment of the present invention is illustrated in FIGS. 3 and 4. The second embodiment of the invention is similar to the first embodiment of the invention illustrated in FIGS. 1 and 2. Accordingly, numerals similar to those of FIGS. 1 and 2 will be utilized in FIGS. 3 and 4 to identify similar components, the suffix letter “a” being associated with the numerals of FIGS. 3 and 4 to avoid confusion. The second embodiment of the present invention is similar to the first embodiment (FIGS. 1 and 2), except that the second embodiment (FIGS. 3 and 4) comprises a driver side front impact air bag.

Referring to FIGS. 3 and 4, the apparatus 10a of the second embodiment comprises a driver side front impact air bag 70 for helping to protect an occupant 20a in a driver side 72 of a vehicle 12a. The occupant 20a is positioned in a seat 22a in the driver side 72 of the vehicle 12a.

As illustrated in FIGS. 3 and 4, the air bag 70 may be part of an air bag module 80 that includes an inflator 82 and a housing 84. The air bag 70 has a stored condition, indicated by dashed lines in FIGS. 3 and 4, in which the air bag is folded and placed in the housing 84. The housing 84 and thus the module 80 is connected to a steering wheel 90 of the vehicle 12a on the driver side 72 of the vehicle. The housing 84 helps contain and support the air bag 70 and inflator 82 in the steering wheel 90.

An air bag cover (not shown) is releasably connected to the steering wheel 90 and/or the housing 84. In a closed condition, the air bag cover forms a cover for the module 80 and helps enclose the air bag 70 in the stored condition in the housing 84. The cover is movable to an opened condition to uncover an opening 94 through which the air bag 70 may be deployed from the stored condition in the housing 84.

The inflator 82 is actuatable to provide inflation fluid for inflating the air bag 70. The inflator 82 may be of any known type, such as stored gas, solid propellant, augmented, and hybrid. The apparatus 10a includes a sensor, illustrated schematically at 50a, for sensing an event for which inflation of the air bag 70 is desired, such as a collision. The inflator 82 is operatively connected to the sensor 50a via lead wires 52a.

Upon sensing the occurrence of an event for which inflation of the air bag 70 is desired, such as a vehicle collision, the sensor 50a provides a signal to the inflator 82 via the lead wires 52a. Upon receiving the signal from the sensor 50a, the inflator 82 is actuated and provides inflation fluid to the air bag 70 in a known manner. The inflating air bag 70 exerts a force on the cover that moves the cover to the opened condition. The air bag 70 inflates from the stored condition to a deployed condition illustrated in solid lines in FIGS. 3 and 4. The air bag 70, while inflated, helps protect the vehicle occupant 20a from impacts with parts of the vehicle 12a, such as the steering wheel 90.

According to the present invention, the air bag 70 includes vents illustrated schematically at 60a. The vents 60a are arranged about an opening of the air bag 70 referred to as a mouth or throat 96 of the air bag. The throat 96 of the air bag 70 is connected to the air bag module 80, e.g., to the housing 84. The inflator 82, when actuated, directs inflation fluid through the throat 96 into the air bag 70. The vents 60a are presented facing toward a surface 62a of the vehicle 12a. In the second embodiment illustrated in FIGS. 3 and 4, the surface 62a comprises a surface of the steering wheel 90 adjacent the opening 94.

In FIG. 3, the occupant 20a moves from a normal seated position in a forward direction indicated generally by the arrow labeled 42a in FIG. 3, toward the instrument panel 36a. At the same time, the air bag 70 inflates and deploys from its stored position in the steering wheel 90. Since the occupant 20a starts moving from the normal seated position, the air bag 70 is free to inflate to a normal inflated position illustrated in FIG. 3. The occupant 20a thus moves into engagement with the normally inflated and positioned air bag 70 as shown in FIG. 3.

When the air bag is in the normally inflated position of FIG. 3, the vents 60a are positioned against the surface 62a. The vents 60a are thus closed and inflation fluid flow through the vents is blocked. When the occupant 20a engages the air bag 70, the occupant pushes the air bag towards the instrument panel 36a and toward the steering wheel 90. As a result, the portion of the air bag 70 including the vents 60a is urged against the surface 62a. This helps hold the vents 60a closed and helps further to block inflation fluid from flowing through the vents. The vents 60a, being held closed when the air bag 70 is in the normally inflated position, helps the air bag maintain a desired inflated pressure. As a result, in the normally inflated position, the air bag 70 helps protect the vehicle occupant 20a from impacts with parts of the vehicle 12a, such as the instrument panel 36a or steering wheel 90.

In FIG. 4, the occupant 20a moves in the forward direction indicated by the arrow labeled 42a into engagement with the air bag 70 from a position in which the occupant is leaned away from the normal seating position of FIG. 3. Specifically, in FIG. 4, the occupant 20a is leaned to the side and twisted away from the normal seating position as the air bag 70 inflates and deploys from its stored position in the steering wheel 90. Since the occupant 20a is positioned away from the normal seated position, the occupant blocks the air bag 70 from inflating to the normal inflated position of FIG. 3. Instead, the air bag 70 inflates to a position away from the normally inflated position, as represented in FIG. 4.

Because the air bag 70 is blocked from inflating to the normal position, at least a portion of the throat 96, and thus at least some of the vents 60a, are spaced away from the surface 62a when the air bag is in the inflated position. Thus, in the inflated condition of FIG. 4, at least some of the vents 60a are free to open and vent inflation fluid from the air bag 70. As a result, the air bag 70 may have a reduced inflation pressure and/or may move toward the occupant 20a with a reduced amount of force.

Those skilled in the art will appreciate that the air bag 70 illustrated in FIGS. 3 and 4, when inflated, is adapted to deploy and pressurize to a normally inflated position when the air bag is free from obstruction. The air bag 70 may thus be maintained at a desired inflation pressure, which allows the air bag to absorb impact forces and help protect the vehicle occupant. The air bag 70 is also adapted to vent inflation fluid when an obstruction, such as an occupant 20a positioned away from the normal seated position, blocks the air bag from inflating and deploying to the normal inflated position. As a result, the air bag 70 may inflate toward the occupant 20a with a reduced force.

The air bag vents 60a of the present invention help maintain the air bag 70 at a desired inflation pressure when deployed to the normally inflated position. The air bag vents 60a of the present invention also help vent inflation fluid from the air bag 70 in the event that the air bag does not inflate to its normal inflated position.

Those skilled in the art will appreciate that, in the embodiments illustrated in FIGS. 1-4, the vents are blocked from releasing inflation fluid when the air bag is inflated to the normal position as shown in FIGS. 1 and 3. It will also be appreciated that the vents release inflation fluid from the air bag when the air bag is blocked from inflating to its normal position, as shown in FIGS. 2 and 4. It will further be appreciated that the air bag may be blocked from inflating to the normally inflated position in a manner other than that shown in FIGS. 2 and 4.

For example, if the occupant is leaned in an inboard or outboard direction (i.e., to the right or left as viewed facing forward in the vehicle), the occupant may block inflation of a lateral portion of the air bag. As another example, if the vehicle is involved in an event that results in the occupant moving toward the air bag in an angular or diagonal direction, such as an angular or offset collision, the occupant may engage a lateral portion of the air bag. As a further example, if an object other than an occupant occupies the vehicle seat, the air bag may be blocked from deploying to the normally inflated position.

In the event that the occupant engages only a portion of the air bag (e.g., during an offset collision), the vents located near the portion of the air bag engaged by the occupant may be urged toward the vehicle surface, while the remaining vents are not urged against the surface or are moved away from the surface. According to the present invention, the location of the vents on the air bags of the first and/or second embodiments may be used to tailor the restraint performance of the air bags.

For example, in an angular or offset collision, the direction of crash forces is angular with respect to the forward direction of vehicle travel (e.g., in the forward directions 42 and 42a of FIGS. 1-4). During these events, the occupant may move toward vehicle structure such as an A-pillar, windshield, side window, or roof/visor of the vehicle. According to the present invention, the air bag may include vents presented toward these structures. Thus, in a collision where the occupant moves the air bag toward these structures, the vents engage the structure and block inflation fluid from venting, which helps increase or maintain pressurization in that region of the air bag. The air bag may thus be adapted to respond to varying dynamic conditions experienced in an angular or offset collision as opposed to a frontal impact.

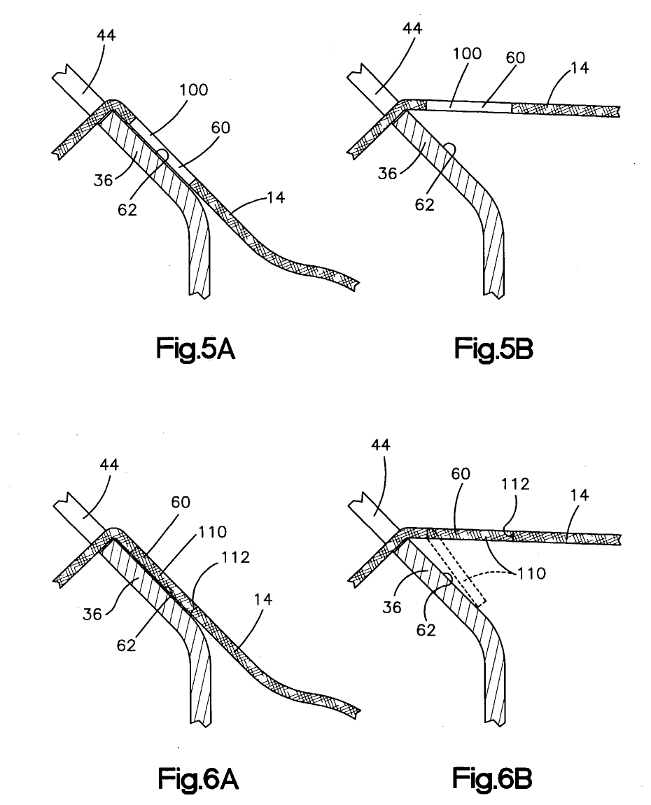

FIGS. 5A-8B illustrate various configurations of the air bag vents depicted in FIGS. 1-4. Any of the vent configurations of FIGS. 5A-8B may be incorporated into the passenger side air bag 14 (FIGS. 1 and 2) or the driver side air bag 70 (FIGS. 3 and 4). For simplicity, FIGS. 5A-8B illustrate vent configurations incorporated in the passenger side air bag 14 of the first embodiment of FIGS. 1 and 2. FIGS. 5A-8B illustrate the passenger side air bag 14, vent 60, and the surface 62 of the instrument panel 36. Those skilled in the art, however, will appreciate that FIGS. 5A-8B are also illustrative of vent configurations that may be incorporated with the driver side air bag 70 of FIGS. 3 and 4.

Referring to FIGS. 5A and 5B, the vents 60 may comprise holes or apertures 100 in the air bag 14. In FIG. 5A, the air bag 14 is shown in a position that corresponds to the position of the air bag illustrated in FIG. 1. In FIG. 5B, the air bag 14 is shown in a position that corresponds to the position of the air bag illustrated in FIG. 2. Referring to FIG. 5A, the apertures 100 are positioned against the surface 62 of the instrument panel 36, thus blocking inflation fluid from venting from the air bag 14. Referring to FIG. 5B, the apertures 100 are spaced from the surface 62 of the instrument panel 36 and thus vent inflation fluid from the air bag 14.

Referring to FIGS. 6A and 6B, the vents 60 may comprise a portion 110 of the air bag 14 defined by a tear seam 112 in the air bag material. For example, the tear seam 112 may comprise perforations in the air bag 14 that release under the pressure of inflation fluid to open the vent 60. The tear seam 112 may have a shape (e.g., a pointed shape) selected to create stress concentrations that cause the seam to tear in a predetermined direction. In FIG. 6A, the air bag 14 is shown in a position that corresponds to the position of the air bag illustrated in FIG. 1. In FIG. 6B, the air bag 14 is shown in a position that corresponds to the position of the air bag illustrated in FIG. 2.

Referring to FIG. 6A, the vent 60 is positioned against the surface 62 of the instrument panel 36. The surface 62 forms a reaction surface that supports the portion 110 and resists the force applied as a result of the inflation fluid pressure in the air bag 14. This helps prevent the tear seam 112 from rupturing under the force of the inflation fluid pressure in the air bag 14. The portion 110 is thus held against opening the vent 60 and thus helps block inflation fluid from venting from the air bag 14.

Referring to FIG. 6B, the vent 60 is spaced from the surface 62 of the instrument panel 36. The inflation fluid pressure in the air bag 14 causes the tear seam 112 to rupture, which releases the portion 110 to move to the position illustrated in dashed lines in FIG. 6B. This opens the vent 60, which releases inflation fluid to vent from the air bag 14.

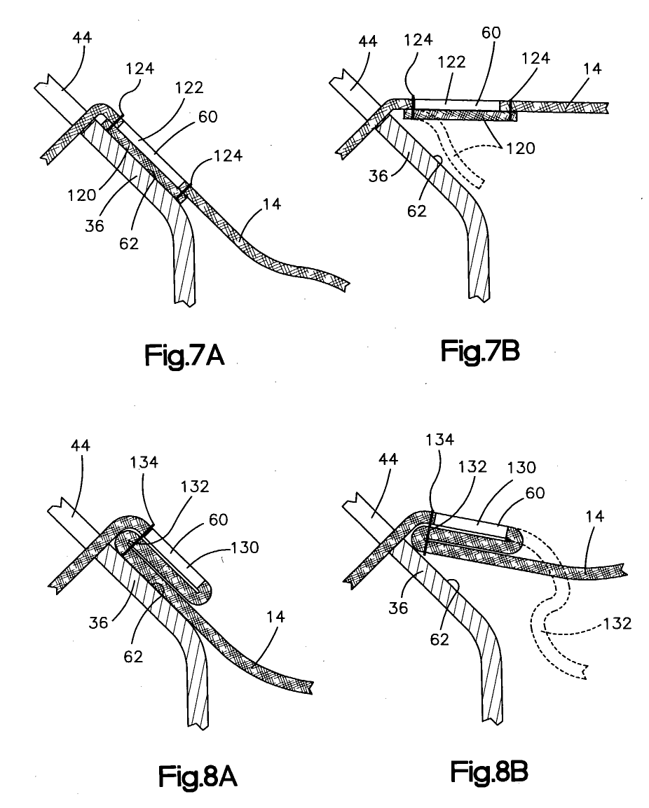

Referring to FIGS. 7A and 7B, the vents 60 may comprise a piece of material 120 that overlies an aperture 122 in the air bag 14. The piece of material 120 is connected to the air bag by means 124, such as stitching or an adhesive. The piece of material 120 may comprise a piece of air bag fabric, a piece of plastic film, a piece of foil, or any other suitable material. In FIG. 7A, the air bag 14 is shown in a position that corresponds to the position of the air bag illustrated in FIG. 1. In FIG. 7B, the air bag 14 is shown in a position that corresponds to the position of the air bag illustrated in FIG. 2.

Referring to FIG. 7A, the vent 60 is positioned against the surface 62 of the instrument panel 36. The surface 62 forms a reaction surface that supports the piece of material 120 and resists the force applied as a result of inflation fluid pressure in the air bag 14. This helps prevent the means 124 from rupturing under the force of the inflation fluid pressure in the air bag 14. The piece of material 120 is thus held positioned overlying the aperture 122 and thus helps block inflation fluid from venting from the air bag 14 through the aperture.

Referring to FIG. 7B, the vent 60 is spaced from the surface 62 of the instrument panel 36. When the air bag 14 is in this position, inflation fluid pressure in the air bag 14 causes the means 124 to rupture, which releases the piece of material 120 and thus unblocks the opening 122, as illustrated in dashed lines in FIG. 7B. The means 124 is designed to release in a predetermined direction once a predetermined pressure is reached. The vent 60 is thus opened and inflation fluid is vented from the air bag 14.

Referring to FIGS. 8A and 8B, the vents 60 comprise an opening 130 in the air bag 14 that is placed in the closed position by folding over the air bag material to form a pleat 132. The pleat 132 is held in place by means 134, such as stitching or an adhesive, that connects the pleat to a portion of the air bag 14 adjacent the vent 60. In FIG. 8A, the air bag 14 is shown in a position that corresponds to the position of the air bag illustrated in FIG. 1. In FIG. 8B, the air bag 14 is shown in a position that corresponds to the position of the air bag illustrated in FIG. 2.

Referring to FIG. 8A, the vent 60 is positioned against the surface 62 of the instrument panel 36. The surface 62 forms a reaction surface that supports the pleat 132 and resists the force applied as a result of the inflation fluid pressure in the air bag 14. This helps prevent the means 134 from rupturing under the force of the inflation fluid pressure in the air bag 14. The pleat 132 is thus held positioned overlying the aperture 130 and thus helps block inflation fluid from venting from the air bag 14 through the aperture.

Referring to FIG. 8B, the vent 60 is spaced from the surface 62 of the instrument panel 36. When the air bag 14 is in this position, inflation fluid pressure in the air bag 14 causes the means 134 to rupture, which releases the pleat 132 and thus unblocks the opening 130, as illustrated in dashed lines in FIG. 8B. The vent 60 is thus opened and inflation fluid is vented from the air bag 14.

From the above description of the invention, those skilled in the art will perceive improvements, changes and modifications. For example, while the air bag vents of the present invention have been illustrated in implementations with driver and passenger side front impact air bags, the air bag vents could be implemented in other inflatable vehicle occupant protection devices. For example, the air bag vents of the present invention could be implemented in a side impact air bag, an inflatable knee bolster, or an inflatable side curtain. Such improvements, changes and modifications within the skill of the art are intended to be covered by the appended claims.

Having described the invention, the following is claimed:

1. Apparatus for helping to protect an occupant of a vehicle, said apparatus comprising:
an inflatable vehicle occupant protection device inflatable to an inflated position for helping to protect an occupant of the vehicle, said inflatable vehicle occupant protection device including at least one vent; and
an inflation fluid source actuatable to provide inflation fluid for inflating said inflatable vehicle occupant protection device;
said at least one vent being positioned against a vehicle surface while said inflatable vehicle occupant protection device is in said inflated position to help block inflation fluid from venting through said at least one vent.

2. Apparatus as recited in claim 1, wherein said inflatable vehicle occupant protection device is inflatable in a direction away from said vehicle surface, said at least one vent being presented toward said vehicle surface when said inflatable vehicle occupant protection device is in said inflated position.

3. Apparatus as recited in claim 1, wherein said vent is movable into engagement with said vehicle surface when a vehicle occupant engages said inflatable vehicle occupant protection device and urges said inflatable vehicle occupant protection device toward said vehicle surface.

4. Apparatus as recited in claim 1, wherein said at least one vent has a position spaced from said vehicle surface when said inflatable vehicle occupant protection device is obstructed from deploying to said inflated position, said at least one vent when spaced from said vehicle surface releasing said inflation fluid to flow out of said inflatable vehicle occupant protection device through said at least one vent.

5. Apparatus as recited in claim 1, further comprising a housing for storing said inflatable vehicle occupant protection device in a stored condition prior to inflation, said housing including an opening through which said inflatable vehicle occupant protection device is inflated to said inflated position, said vehicle surface at least partially surrounding said opening.

6. Apparatus as recited in claim 5, wherein said at least one vent comprises a plurality of vents presented toward said vehicle surface at locations on said inflatable vehicle occupant protection device spaced about said opening.

7. Apparatus as recited in claim 1, wherein said inflatable vehicle occupant protection device comprises an inflatable passenger side air bag inflatable from a stored position in an instrument panel of the vehicle, said vehicle surface comprising a portion of the instrument panel.

8. Apparatus as recited in claim 1, wherein said inflatable vehicle occupant protection device comprises an inflatable driver side air bag inflatable from a stored position on a steering wheel of the vehicle, said vehicle surface comprising a portion of the steering wheel.

9. Apparatus for helping to protect an occupant of a vehicle, said apparatus comprising:
an inflatable vehicle occupant protection device inflatable to an inflated position for helping to protect an occupant of the vehicle; and
an inflation fluid source actuatable to provide inflation fluid for inflating said inflatable vehicle occupant protection device;
said inflatable vehicle occupant protection device including means positioned against a vehicle surface while said inflatable vehicle occupant protection device is in said inflated position to help block release of inflation fluid from said inflatable vehicle occupant protection device.

10. Apparatus as recited in claim 9, wherein said means has a position spaced from said vehicle surface when said inflatable vehicle occupant protection device is obstructed from deploying to said inflated position, said means when spaced from said vehicle surface releasing said inflation fluid to flow out of said inflatable vehicle occupant protection device.

11. Apparatus for helping to protect an occupant of a vehicle, said apparatus comprising:
an air bag inflatable away from a vehicle surface to an inflated position for helping to protect an occupant of the vehicle, said air bag including a throat for receiving inflation fluid and at least one vent spaced about said throat; and
an inflation fluid source actuatable to provide inflation fluid for inflating said air bag;
said at least one vent being presented facing said vehicle surface and positioned against said vehicle surface when said air bag is in said deployed position, said inflation fluid being blocked from venting through said at least one vent when said vent is moved into engagement with said vehicle surface.

12. Apparatus for helping to protect an occupant of a vehicle, said apparatus comprising:
an air bag inflatable away from a vehicle surface to an inflated position for helping to protect an occupant of the vehicle, said air bag being adapted to vent inflation fluid when moved away from said inflated position.
